(19) United States
(12) Patent Application Publication
(10) Pub. No.: US 2006/0248911 A1
(43) Pub. Date: Nov. 9, 2006

(54) Ice dispenser and refrigerator comprising the same

(75) Inventors: Hye Kyoung An, Pusan-city (KR); Ho Sang Park, Gwangju-City (KR); Hak Gyun Bae, Andong-si (KR)

Correspondence Address: STAAS & HALSEY LLP, SUITE 700, 1201 NEW YORK AVENUE, N.W., WASHINGTON, DC, 20005, US

(73) Assignee: SAMSUNG ELECTRONICS CO., LTD., Suwon-si (KR)

(21) Appl. No.: 11/364,031

(22) Filed: Mar. 1, 2006

(30) Foreign Application Priority Data
May 4, 2005 (KR) 2005-37379

(51) Int. Cl. F25C 5/18; B65G 1/00

(52) U.S. Cl. 62/344; 414/311

(57) ABSTRACT

An ice dispenser and a refrigerator having the ice dispenser. The ice dispenser includes a spiral conveying unit to convey the ice cubes to the outlet of the ice bucket while rotating, and a rotating blade unit rotatably equipped at the other side within the ice bucket to fluctuate the ice cubes located at a side of the spiral conveying unit, such that the ice cubes located far from the spiral conveying unit are moved. Thus, agglomeration of the ice cubes in the ice bucket which has an increased width can be prevented.

### CROSS-REFERENCE TO RELATED APPLICATIONS

This application claims the benefit of Korean Patent Application No. 2005-0037379, filed on May 4, 2005 in the Korean Intellectual Property Office, the disclosure of which is incorporated herein by reference.

### BACKGROUND OF THE INVENTION

1. Field of the Invention

The present invention relates to an ice dispenser and a refrigerator including the same. More particularly, the present invention relates to an ice dispenser, which can reduce agglomeration of ice cubes, and a refrigerator including the same.

2. Description of the Related Art

Generally, a conventional refrigerator includes various components constituting a cooling cycle, and generates cold air to freeze or refrigerate foods contained therein. One example of the conventional refrigerator is disclosed in Korean Patent Laid-open Publication No. 10-2002-59479, which includes an icemaker to produce ice cubes, and an ice dispenser to allow the ice cubes produced by the icemaker to be dispensed without opening a door.

The ice dispenser includes an ice bucket to contain the ice cubes produced by the icemaker and having an outlet formed at one side of the ice barrel to discharge the ice cubes, a spiral ice conveying unit positioned in the ice bucket to convey the ice cubes into the outlet while being rotated by a motor, and a crusher positioned at the outlet to crush the ice cubes conveyed by the conveying unit, and a compressing member to compress the ice cubes into the crusher.

Recently, refrigerators have been gradually increased in dimensions in response to market demands, and accordingly, the sizes of the icemaker and the ice bucket for large capacity refrigerators have also increased. However, since there is no difference in volume of the ice cube between a general refrigerator and a large capacity refrigerator, the size of the conveying unit is not changed independently of a change in dimensions of the refrigerator.

Thus, if such a conveying unit having the same size as that of the typical conveying unit is used in the ice bucket having an increased width, the ice cubes contained adjacent to the conveying unit can be conveyed to the outlet through the conveying unit even under lower consumption of ice cubes so that these ice cubes are replaced with new ones. The ice cubes contained at a location far from the conveying unit can be conveyed to the outlet through the conveying unit under condition of higher consumption of ice cubes so that these ice cubes are not discharged for a long period of time, and are accumulated in the ice bucket. When the ice cubes are accumulated in the ice bucket for a long period of time, there is a possibility of agglomeration of the ice cubes.

### SUMMARY OF THE INVENTION

Accordingly, it is an aspect of the present invention to provide an ice dispenser which can prevent agglomeration of ice cubes frequently occurring in an ice bucket having an increased width in response to an enlargement of a refrigerator, and a refrigerator including the same.

Additional aspects and/or advantages of the invention will be set forth in part in the description which follows and, in part, will be apparent from the description, or may be learned by practice of the invention.

The foregoing and/or other aspects of the present invention are achieved by providing an ice dispenser including a spiral conveying unit to convey ice cubes while rotating, and a rotating blade unit rotatably equipped at one side of the conveying unit to fluctuate the ice cubes located at the side of the spiral conveying unit while rotating.

The rotating blade unit includes a plurality of blades extending radially, and uniformly spaced a predetermined distance from each other in a circumferential direction.

At least one of the blades is alternately brought into contact with the conveying unit such that the rotating blade unit can be rotated via a force transmitted from the conveying unit.

Each of the blades extends slantly in an upward direction to fluctuate the ice cubes located at the side of the spiral conveying unit, upwardly and downwardly.

It is another aspect of the present invention to provide an ice bucket including an outlet to discharge ice cubes, a spiral conveying unit equipped at one side within the ice bucket to convey the ice cubes to the outlet of the ice bucket while rotating, and a rotating blade unit rotatably equipped at the other side within the ice bucket to fluctuate the ice cubes located at a side of the spiral conveying unit.

It is yet another aspect of the present invention to provide an ice dispenser including an ice bucket having an outlet to discharge ice cubes, a spiral conveying unit equipped at one side within the ice bucket to convey the ice cubes to the outlet of the ice bucket while rotating, and a rotating blade unit rotatably equipped on a bottom surface at the other side within the ice bucket to fluctuate the ice cubes located at a side of the spiral conveying unit.

The ice bucket further includes an installation opening on the bottom surface at the other side to allow the rotating blade unit to be rotatably equipped therethrough, and a seat portion located around the installation opening and protruding from the bottom surface at the other side to allow a lower surface of the rotating blade unit to be separated a predetermined distance from the bottom surface of the ice bucket.

The rotating blade unit includes a supporting part extending substantially parallel to the bottom surface of the ice bucket in order to reduce slanting of the rotating blade.

It is yet another aspect of the present invention to provide a refrigerator including a main body defining an outer appearance, the refrigerator including a freezing compartment to freeze foods stored therein, a door positioned at one side of the main body to open and close the freezing compartment, an icemaker positioned in the freezing compartment to produce ice cubes, and an ice dispenser to dispense the ice cubes produced by the icemaker to an outside of the refrigerator without opening the door, wherein the ice dispenser includes an ice bucket having an outlet to discharge ice cubes, a spiral conveying unit equipped at one side within the ice bucket to convey the ice cubes to the outlet of the ice bucket while rotating, and a rotating blade unit rotatably equipped at the other side within the ice bucket to fluctuate the ice cubes located at a side of the spiral conveying unit.

### BRIEF DESCRIPTION OF THE DRAWINGS

These and/or other aspects and advantages of the invention will become apparent and more readily appreciated from the following description of the embodiments, taken in conjunction with the accompanying drawings of which:

FIG. 1 is a cross-sectional view illustrating a refrigerator having an ice dispenser in accordance with an embodiment of the present invention;

FIG. 2 is a perspective view illustrating the ice dispenser;

FIG. 3 is a perspective view illustrating operation of the ice dispenser; and

FIG. 4 is an exploded perspective view illustrating a rotating blade unit of the ice dispenser.

### DETAILED DESCRIPTION OF THE PREFERRED EMBODIMENTS

Reference will now be made in detail to the embodiments of the present invention, examples of which are illustrated in the accompanying drawings, wherein like reference numerals refer to the like elements throughout. The embodiments are described below to explain the present invention by referring to the figures.

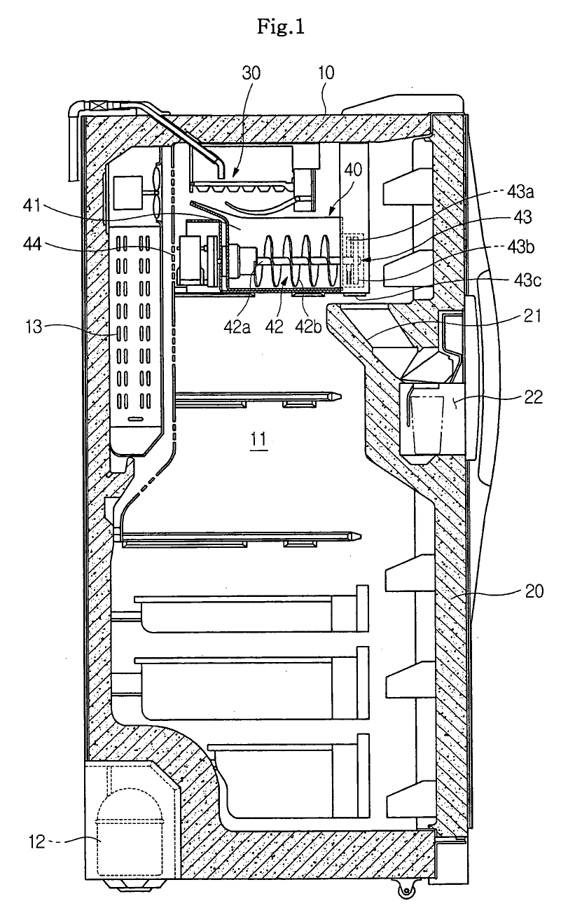

In FIG. 1, a refrigerator according to an embodiment of the present invention comprises a body 10 defining an appearance of the refrigerator and being opened at a front side thereof to store foods. The body 10 comprises a freezing compartment 11 defined therein, and a door 20 hinged to one side of the body 10 to open and close the freezing compartment 11. The refrigerator further comprises a compressor 12, a condenser (not shown), an evaporator 13, an expansion valve (not shown), which constitute a cooling cycle within the body 10 to generate cold air to cool an interior of the freezing compartment 11. The compressor 10 is positioned at a lower portion of the body 10, and the evaporator 13 is positioned on a rear wall of the body 10.

The refrigerator further comprises an icemaker 30 positioned at an upper portion of the freezing compartment 11 to produce ice cubes, and an ice dispenser 40 positioned below the icemaker 30 to store and discharge the ice cubes to an outside of the refrigerator, if necessary. The door 20 comprises a discharge guide pipe 21 communicated with an interior of the freezing compartment 11 to discharge of the ice cubes such that the ice cubes produced by the icemaker 30 can be dispensed to a user without opening the door 20, and an ice cube outlet port 22 formed on a front side of the door 20 and depressed into the door 20 so as to permit the user to easily receive the ice cubes discharged through the discharge guide pipe 21.

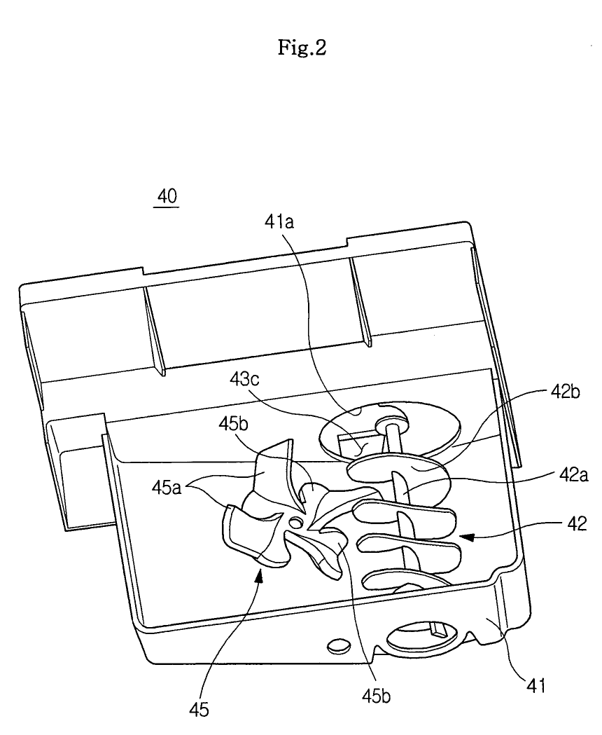

In FIG. 2, the ice dispenser 40 comprises an ice bucket 41 positioned below the icemaker 30 to receive ice cubes dropped from the icemaker 30 and having an outlet 41a formed at one side thereof to discharge the ice cubes, a conveying unit 42 rotatably positioned at one side within the ice bucket 41 to convey the ice cubes contained in the ice bucket 41 to the outlet 41a while rotating, and an ice crusher 43 positioned at the outlet 41a to selectively crush the ice cubes discharged through outlet 41a.

An upper portion of the ice bucket 41 is open to receive the ice cubes discharged from the ice maker 30, and a bottom surface of the ice bucket 41 is slanted upwardly towards both sides of the conveying unit 42, from a portion where the conveying unit 42 is positioned in the ice bucket 41, such that the ice cubes can be conveyed towards the conveying unit 42 by their weight.

The conveying unit 42 comprises a conveying shaft 42a connected at one end with a driving motor 44 to receive power transmitted from the driving motor 44 which generates a rotating force, and a spiral conveying screw 42b formed around an outer periphery of the conveying shaft 42a to convey the ice cubes towards the outlet 41a while rotating together with the conveying shaft 42a.

The ice crusher 43 comprises a stationary cutter 43a fixed at the outlet 41 a of the ice bucket 41, and a rotational cutter 43b rotating together with the conveying unit 42. A discharge port 43c is formed below the ice crusher 43 to discharge crushed ice towards the discharge guide pipe 21. Thus, when being conveyed into the ice crusher 43 by the conveying unit 42, the ice cubes are jammed between the stationary cutter 43a and the rotational cutter 43b to be crushed thereby, and then the crushed ice is discharged to the outside of the refrigerator via the discharge port 43c and the discharge guide pipe 21.

In addition, in order to prevent agglomeration of the ice cubes frequently occurring in the ice bucket 41 having an increased width, the conveying unit 42 is positioned adjacent to one side within the ice bucket 41, and a rotating blade unit 45 is rotatably equipped on a bottom surface at the other side within the ice bucket 41 by means of a pin 45c to fluctuate the ice cubes in the ice bucket 41.

The rotating blade unit 45 comprises a plurality of blades 45a which extend radially, and are uniformly spaced a predetermined distance from each other in a circumferential direction. At least one of the blades 45a is alternately brought into contact with the conveying screw 42b of the conveying unit 42 during rotation of the rotating blade unit 45, such that the rotating blade unit 45 can be rotated by the force transmitted via the conveying screw 42b while the conveying unit 42 rotates. Each of the blades 45a extends slantly in an upward direction, so that the ice cubes positioned on the rotating blade unit 45 moves along a slanted upper surface of the blades 45a while fluctuating up and down within the ice bucket 41.

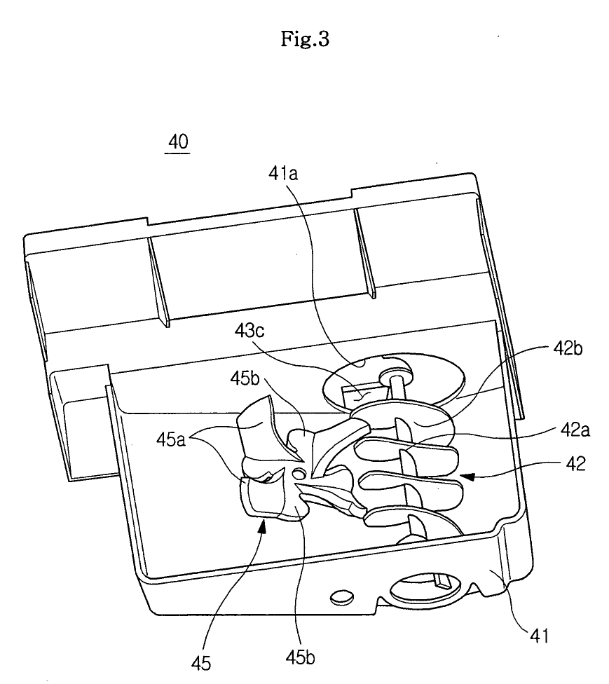

Consequently, the conveying unit 42 acts as a driving gear of a bevel gear, and the rotating blade unit 45 acts as a driven gear of the bevel gear. Thus, as the conveying unit 42 rotates, one of the blades 45a brought into contact with the conveying unit 42 is rotated by force transmitted from the conveying unit 42 as shown in FIG. 2, so that the rotating blade unit 45 starts to rotate. When the rotating blade unit 45 rotates a predetermined angle or more, another blade 45a located at a rear side of the rotating blade unit 45 in a rotating direction thereof is brought into contact with the conveying unit 42, and further rotated by the force transmitted from the conveying unit 42 as shown in FIG. 3, so that the rotating blade unit 45 continues to rotate.

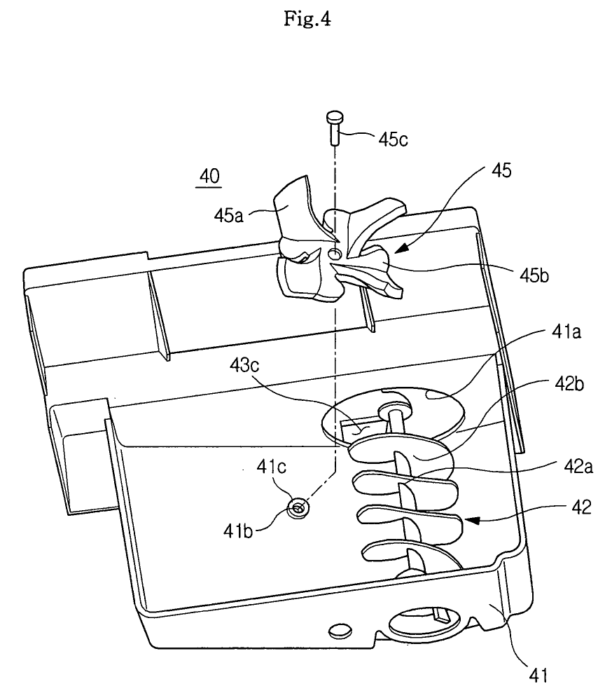

In FIG. 4, the ice bucket 41 further comprises an installation opening 41b on the bottom surface at the other side thereof such that the rotating blade unit 45 is rotatably equipped via the installation opening 41b to the other side within the ice bucket 41, and a ring-shaped seat portion 41c protruding from the bottom surface of the ice bucket 41 around the installation opening 41b to allow a lower surface of the rotating blade unit 45 to support the ice bucket 41, and to allow smooth rotation of the rotating blade unit 45. Thus, the lower surface of the rotating blade unit 45 is substantially separated a predetermined distance from the bottom surface of the ice bucket 41 while being brought into contact with the seat portion 41c. As a result, it is possible to minimize friction between the lower surface of the rotating blade unit 45 and the bottom surface of the ice bucket 41.

In addition, the rotating blade unit 45 further comprises a supporting part 45b in order to reduce slanting of the rotating blade unit 45 a predetermined degree or more due to the weight of the ice cubes loaded on the rotating blade unit 45. The supporting part 45b extends substantially parallel to the bottom surface of the ice bucket 41 in the circumferential direction, such that even though the rotating blade unit 45 is slanted due to the weight of the ice cubes, the rotating blade unit 45 is supported by the supporting part 45b, and thus prevented from being slanted a predetermined degree or more.

As apparent from the above description, the ice dispenser according to an embodiment of the present invention, and the refrigerator comprising the same include the rotating blade unit to fluctuate the ice cubes located at the side of the conveying unit up and down within the ice bucket, thereby preventing agglomeration of the ice cubes in the ice bucket which has an increased width.

Although a few embodiments of the present invention have been shown and described, it would be appreciated by those skilled in the art that various modifications, additions and substitutions may be made in these embodiments without departing from the principle and spirit of the invention, the scope of which defined in the claims and their equivalents.

What is claimed is:

1. An ice dispenser comprising:
a spiral conveying unit to convey ice cubes while rotating; and
a rotating blade unit rotatably equipped at one side of the spiral conveying unit to fluctuate the ice cubes located at the side of the spiral conveying unit while rotating.

2. The ice dispenser according to claim 1, wherein the rotating blade unit comprises a plurality of blades extending radially, and uniformly spaced a predetermined distance from each other in a circumferential direction.

3. The ice dispenser according to claim 2, wherein at least one of the blades is alternately brought into contact with the spiral conveying unit such that the rotating blade unit can be rotated via a force transmitted from the conveying unit.

4. The ice dispenser according to claim 2, wherein each of the blades extends slantly in an upward direction to fluctuate the ice cubes located at the side of the spiral conveying unit upwardly and downwardly.

5. An ice dispenser comprising:
an ice bucket comprising an outlet to discharge ice cubes;
a spiral conveying unit equipped at one side within the ice bucket to convey the ice cubes to the outlet of the ice bucket while rotating; and
a rotating blade unit rotatably equipped at the other side within the ice bucket to fluctuate the ice cubes located at a side of the spiral conveying unit.

6. The ice dispenser according to claim 5, wherein the rotating blade unit comprises a plurality of blades extending radially, and uniformly spaced a predetermined distance from each other in a circumferential direction.

7. The ice dispenser according to claim 6, wherein at least one of the blades is alternately brought into contact with the spiral conveying unit such that the rotating blade unit can be rotated via a force transmitted from the spiral conveying unit.

8. The ice dispenser according to claim 6, wherein each of the blades extends slantly in an upward direction to fluctuate the ice cubes located at the side of the spiral conveying unit upwardly and downwardly.

9. An ice dispenser comprising:
an ice bucket comprising an outlet to discharge ice cubes;
a spiral conveying unit equipped at one side within the ice bucket to convey the ice cubes to the outlet of the ice bucket while rotating; and
a rotating blade unit rotatably equipped on a bottom surface at the other side within the ice bucket to fluctuate the ice cubes located at a side of the conveying unit.

10. The ice dispenser according to claim 9, wherein the ice bucket further comprises:
an installation opening on the bottom surface at the other side to allow the rotating blade unit to be rotatably equipped therethrough, and
a seat portion located around the installation opening and protruding from the bottom surface at the other side to allow a lower surface of the rotating blade unit to be separated a predetermined distance from the bottom surface of the ice bucket.

11. The ice dispenser according to claim 9, wherein the rotating blade unit comprises a supporting part extending substantially parallel to the bottom surface of the ice bucket in order to reduce slanting of the rotating blade.

12. A refrigerator having a main body defining an outer appearance, the refrigerator comprising:
a freezing compartment to freeze foods stored therein;
a door positioned at one side of the main body to open and close the freezing compartment;
an icemaker positioned in the freezing compartment to produce ice cubes; and
an ice dispenser to dispense the ice cubes produced by the icemaker to an outside of the refrigerator without opening the door, wherein the ice dispenser comprises:
an ice bucket comprising an outlet to discharge ice cubes,
a spiral conveying unit equipped at one side within the ice bucket to convey the ice cubes to the outlet of the ice bucket while rotating, and
a rotating blade unit rotatably equipped at the other side within the ice bucket to fluctuate the ice cubes located at a side of the spiral conveying unit.

13. The refrigerator according to claim 12, wherein the rotating blade unit comprises a plurality of blades extending radially, and uniformly spaced a predetermined distance from each other in a circumferential direction.

14. The refrigerator according to claim 13, wherein at least one of the blades is alternately brought into contact with the spiral conveying unit such that the rotating blade unit can be rotated via force transmitted from the spiral conveying unit.

15. The refrigerator according to claim 13, wherein each of the blades extends slantly in an upward direction to fluctuate the ice cubes located at the side of the spiral conveying unit upwardly and downwardly.

16. The refrigerator according to claim 12, wherein the ice bucket further comprises:
an installation opening on the bottom surface at the other side to allow the rotating blade unit to be rotatably equipped therethrough; and
a seat portion located around the installation opening and protruding from the bottom surface at the other side to allow a lower surface of the rotating blade unit to be separated a predetermined distance from the bottom surface of the ice bucket.

17. The refrigerator according to claim 12, wherein the rotating blade unit comprises a supporting part extending substantially parallel to the bottom surface of the ice bucket in order to reduce slanting of the rotating blade.
